(19) United States
(12) Patent Application Publication
(10) Pub. No.: US 2026/0135318 A1
(43) Pub. Date: May 14, 2026

(54) CONNECTOR

(71) Applicant: DONGGUAN LEADER PRECISION INDUSTRY CO., LTD., Dongguan City (CN)

(72) Inventors: Tengfei ZHANG, Dongguan City (CN); Bo WANG, Dongguan City (CN); Jiamei WAN, Dongguan City (CN); Bin ZHANG, Dongguan City (CN)

(73) Assignee: DONGGUAN LEADER PRECISION INDUSTRY CO., LTD., Dongguan City (CN)

(21) Appl. No.: 19/384,480

(22) Filed: Nov. 10, 2025

(30) Foreign Application Priority Data
Nov. 11, 2024 (CN) 202411604871.4

(51) Int. Cl. H01R 13/426; H01R 13/502

(52) U.S. Cl. CPC H01R 13/426; H01R 13/5025

(57) ABSTRACT

Disclosed is a connector including: an insulating seat provided with an accommodating cavity and including a first end and a second end that are disposed opposite in a first direction, in which the first end of the insulating seat is provided with a socket, the second end of the insulating seat is provided with a boss, and the boss is provided with a first opening in communication with the accommodating cavity; a conductive terminal disposed in the accommodating cavity; and a cover plate embedded in the first opening, configured to fix the conductive terminal, and provided with at least two limiting structures that abut a side of the boss facing the first opening and are disposed opposite in a second direction, the first direction intersecting the second direction.

### CROSS-REFERENCE TO RELATED APPLICATION

The present disclosure claims priority of Chinese Patent Application No. 202411604871.4 filed on November 11, 2024 and entitled “Connector”, which is explicitly incorporated herein by reference in its entirety.

### FIELD

The present disclosure relates to the technical field of connectors, particularly to a connector.

### BACKGROUND

As functions of electronic products become increasingly rich, requirements for connection stability, shielding performance, and the like of connector products also become higher. In the related art, a vertical connector generally includes an insulating main body, a conductive terminal, and a rear cover.

At present, according to the conventional design of the vertical connector, the conductive terminal and the rear cover are assembled, and then the rear cover is fixedly mounted to the insulating main body. During the process of assembling the rear cover and the insulating main body, high-temperature glue or high-temperature tape needs to be applied between the rear cover and the insulating main body to achieve a fixed connection therebetween. However, during a solidification process of the high-temperature glue or high-temperature tape, the rear cover may be affected by an external force and deviate relative to the insulating main body, in particular, the rear cover may slide left and right under external forces on both sides thereof, affecting reliability of the rear cover in fixing the conductive terminal and even affecting an overall conductive performance and normal operation of the connector.

### SUMMARY

An embodiment of the disclosure provides a connector including: an insulating seat provided with an accommodating cavity and including a first end and a second end that are disposed opposite in a first direction, wherein the first end of the insulating seat is provided with a socket, the second end of the insulating seat is provided with a boss, and the boss is provided with a first opening in communication with the accommodating cavity; a conductive terminal disposed in the accommodating cavity; and a cover plate embedded in the first opening, configured to fix the conductive terminal, and provided with at least two limiting structures that abut a side of the boss facing the first opening and are disposed opposite in a second direction, the first direction intersecting the second direction.

### BRIEF DESCRIPTION OF THE DRAWINGS

FIG. 1 is a structure diagram of a connector provided in an embodiment of the present disclosure;

FIG. 2 is a side view of the connector shown in FIG. 1;

FIG. 3 is a perspective view of the connector shown in FIG. 1;

FIG. 4 is an exploded structure diagram of the connector shown in FIG. 1;

FIG. 5 is a perspective view of an insulating seat of the connector shown in FIG. 1;

FIG. 6 is a rear view of the insulating seat shown in FIG. 5;

FIG. 7 is a first perspective view of a cover plate of the connector shown in FIG. 1;

FIG. 8 is a second perspective view of the cover plate shown in FIG. 7;

FIG. 9 is a front view of the cover plate shown in FIG. 8;

FIG. 10 is a perspective view of a conductive terminal of the connector shown in FIG. 1;

FIG. 11 is a bottom view of the conductive terminal shown in FIG. 10;

FIG. 12 is a structure diagram of a conductive terminal provided in another embodiment; and

FIG. 13 is a schematic diagram of mounting the conductive terminal shown in FIG. 12 and an insulating seat.

### DETAILED DESCRIPTION

In order to make objects, technical solutions, and advantages of embodiments of the disclosure clearer, the technical solutions in the embodiments of the disclosure will be clearly and fully described in combination with the accompanying drawings in the embodiments of the present disclosure. Obviously, the embodiments to be described are part of embodiments but not all embodiments of the disclosure. Based on the embodiments of the disclosure, all other embodiments obtained by those of ordinary skill in the art without inventive work shall fall within the scope of the disclosure.

Many different embodiments or examples are disclosed below to realize different structures of the disclosure. In order to simplify the disclosure, components and arrangements of specific examples are described below. Of course, they are only exemplary and are not intended to limit the disclosure. Furthermore, the present disclosure may repeat reference numerals and/or letters in different examples. The repetition is for simplicity and clarity, and in itself does not indicate the relationship between the various examples and/or arrangements discussed.

For the convenience of description, spatial relationship terms can be used herein to describe the relative positional relationship or movement of one element or feature relative to another element or feature as shown in the drawings, such as “inside”, “outside”, “inner”, “outer”, “under”, “below”, “on”, “above”, “front” and “back”. This spatial relationship term is intended to include different orientations of the device in use or operation other than orientations depicted in the drawings. For example, if the device in the drawings has a position turnover, a posture change or a movement state change, these directional indications will change accordingly. For example, elements described as “under or below other elements or features” will be subsequently oriented as “on or over other elements or features”. Thus, the exemplary term “below” may include both orientations of above and below. The device may be otherwise oriented (rotated by 90 degrees or in other directions), and the spatial relationship description used herein are interpreted accordingly.

Hereinafter, some embodiments of the present disclosure will be described in detail with reference to the accompanying drawings. In the case of no conflict, the following examples and features in the embodiments can be combined with each other.

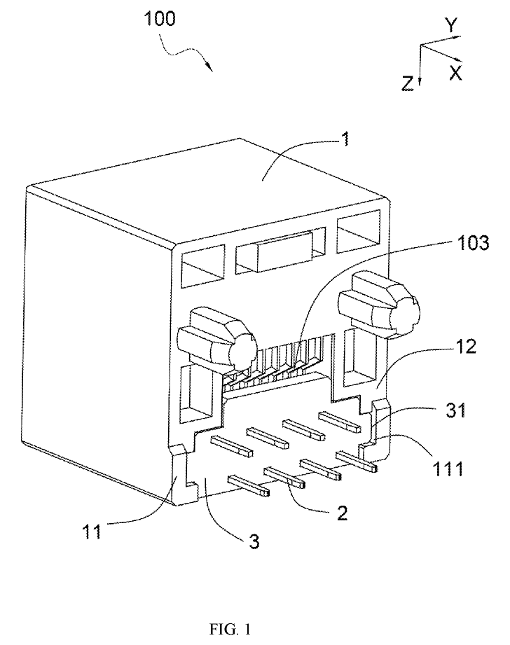

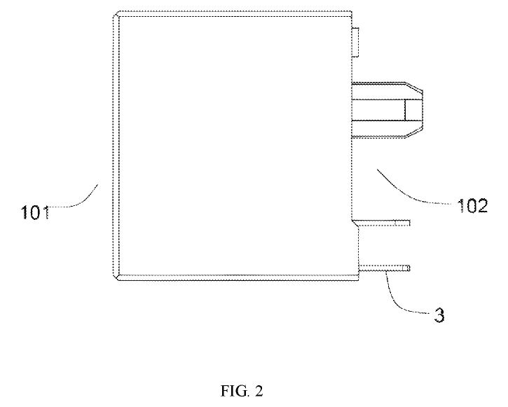

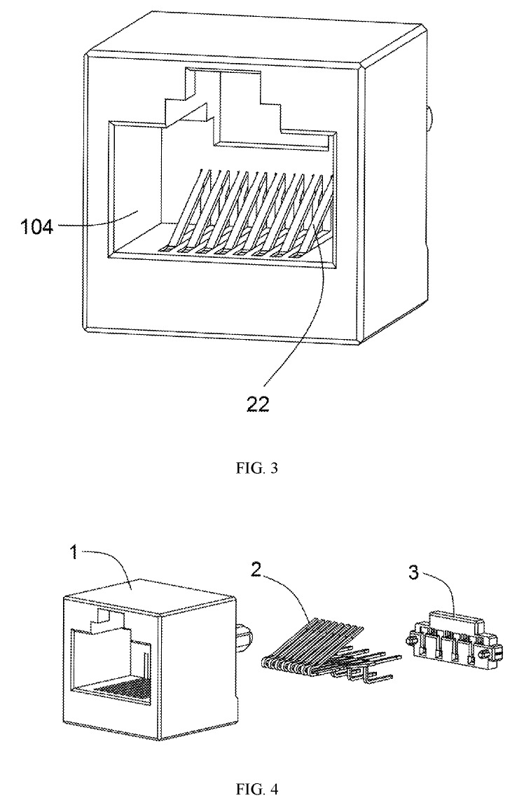

FIGS. 1 to 3 show a connector 100 provided in an embodiment of the present disclosure. The connector 100 includes an insulating seat 1, a conductive terminal 2 and a cover plate 3. The insulating seat 1 is provided with an accommodating cavity 103 and includes a first end 101 and a second end 102 that are disposed opposite in a first direction. The first end 101 of the insulating seat 1 is provided with a socket 104. The second end 102 of the insulating seat 1 is provided with a boss 11, and the boss 11 is provided with a first opening 111 in communication with the accommodating cavity 103. The conductive terminal 2 is disposed in the accommodating cavity 103. The cover plate 3 is embedded in the first opening 111, is configured to fix the conductive terminal 2, and is provided with at least two limiting structures 31 that abut a side of the boss 11 facing the first opening 111. The at least two limiting structures 31 are disposed opposite in a second direction. The first direction intersects the second direction.

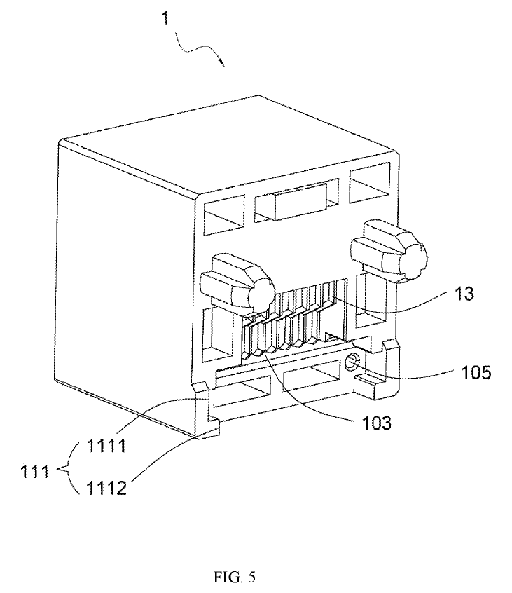

For ease of explanation and understanding, the first direction may be an X direction shown in the drawings, the second direction may be a Y direction shown in the drawings, and two ends of the first direction are respectively referred to as a front and a rear. It can be understood that, as shown in FIG. 4, in the assembly process, the conductive terminal 2 is mounted in the accommodating cavity 103 of the insulating seat 1 from the rear to the front along the first direction, then a side of the cover plate 3 facing the insulating seat 1 is pressed against the conductive terminal 2, and the cover plate 3 is pushed into the first opening 111 of the boss 11 from the rear to the front along the first direction, so that the limiting structure 31 of the cover plate 3 abuts an inside wall of the boss 11. After being mounted in place, a part of the conductive terminal 2 is exposed in the socket 104, and an external electrical appliance is plugged to the socket 104 of the insulating seat 1, thereby achieving electrical conduction through the part of the conductive terminal 2. By abutting connection between the limiting structure 31 and the inside wall of the boss 11, the inside wall of the boss 11 provides static friction for the cover plate 3 to prevent the cover plate 3 from falling off, thereby improving the connection stability between the cover plate 3 and the insulating seat 1. During the process of plugging the external electrical appliance to the socket 104 of the insulating seat 1, even if the conductive terminal 2 is subjected to an extrusion force, the cover plate 3 can prevent the conductive terminal 2 from retreating. Since the cover plate 3 is embedded in the first opening 111, the cover plate 3 can be completely embedded in the first opening 111, that is, a side of the boss 11 facing away from the insulating seat 1 protrudes relative to a side of the cover plate 3 facing away from the insulating seat 1, so that the boss 11 can protect the cover plate 3 and prevent the cover plate 3 from moving up and down or left and right due to external pressure. Therefore, reliability of the rear cover in fixing the conductive terminal 2 can be improved, thereby ensuring the overall conductive performance and normal operation of the connector 100. If the cover plate 3 needs to be disassembled, a force away from the insulating seat 1 can be applied to the cover plate 3 without additional working tools, making the disassembly convenient. Compared with the related art, the connector 100 does not need high-temperature glue or high-temperature tape, which can improve the production efficiency on the one hand and improve the overall strength and pressure resistance of the connector 100 on the other hand.

It should be noted that the cover plate 3 is provided with at least two limiting structures 31, which means that three, four, or more limiting structures 31 may be provided. The present disclosure does not impose any specific limitation on the number of the limiting structures 31.

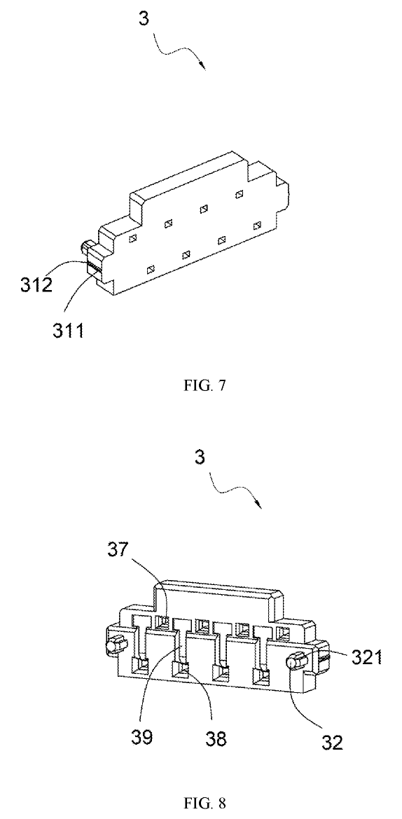

In one example, as shown in FIG. 7, the limiting structure 31 includes limiting ribs 311. Two of the limiting ribs 311 are provided on two sides of the cover plate 3, respectively, and an end of the limiting rib 311 extends toward the accommodating cavity 103. The cover plate 3 is embedded in the first opening 111 of the boss 11, and the limiting rib 311 is pressed against the inside wall of the boss 11, so that the inside walls of the boss 11 provide static friction for the cover plate 3 to prevent the cover plate 3 from falling off, thereby improving the connection stability between the cover plate 3 and the insulating seat 1. An end of the limiting rib 311 extends toward the accommodating cavity 103, which increases contact area between the limiting rib 311 and the inside wall of the boss 11, thereby increasing the static friction between the limiting rib 311 and the inside wall of the boss 11. The two limiting ribs 311 are provided on two sides of the cover plate 3, respectively, so that the boss 11 can provide static friction for the two sides of the cover plate 3. Accordingly, the cover plate 3 receives a more balanced force and is unlikely to fall off.

Furthermore, a wedge-shaped surface 312 is provided at the end of the limiting rib 311 toward the accommodating cavity 103. During the mounting process of the cover plate 3, the wedge-shaped surface 312 can play a guiding role to facilitate mounting and disassembly of the cover plate 3.

In another example, the limiting structure 31 may further include a plurality of limiting protrusions that are spaced apart along the first direction. When the cover plate 3 is embedded in the first opening 111 of the boss 11, the limiting protrusions are pressed against the inside wall of the boss 11, so that the inside wall of the boss 11 provides static friction for the cover plate 3 to prevent the cover plate 3 from falling off the insulating seat 1.

In some embodiments, as shown in FIGS. 5 and 8, the second end 102 of the insulating seat 1 is provided with a positioning hole 105, and the side of the cover plate 3 facing the insulating seat 1 is provided with a positioning column 32 to be lockingly connected with the positioning hole 105. Specifically, the positioning hole 105 can be formed in a square, a circle, a trapezoid, or other shapes, and a cross-section of the positioning column 32 can be formed in a square, a circle, a trapezoid, or other shapes correspondingly, which is not limited in the embodiment of the present disclosure. During the mounting process of the cover plate 3, the side of the cover plate 3 having the positioning column 32 is directed toward the insulating seat 1, the positioning column 32 is aligned with the positioning hole 105, and then the cover plate 3 is pushed into the first opening 111 of the boss 11 along the first direction, so that the positioning column 32 is locked with the positioning hole 105, thereby achieving positioning of the cover plate 3, avoiding the cover plate 3 from deviation or dislocation, thereby improving the reliability of the cover plate 3 in fixing the conductive terminal 2.

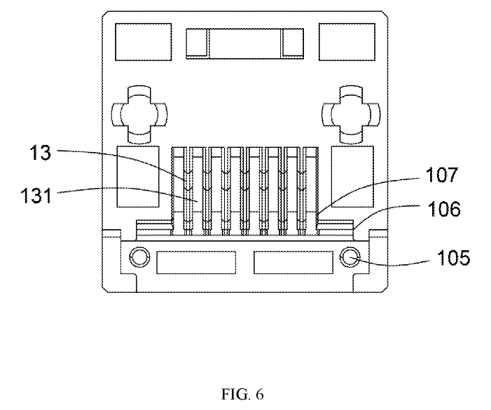

Furthermore, a plurality of positioning holes 105 are provided, and a plurality of positioning columns 32 are provided in one-to-one correspondence with the positioning holes 105, and an end of the positioning column 32 away from the cover plate 3 extends along the first direction. As shown in FIG. 6, in this embodiment, two positioning holes 105 are provided, and two positioning columns 32 are also provided. The two positioning columns 32 are provided on two sides of the first direction, respectively. The plurality of positioning holes 105 can restrict the cover plate 3 from being displaced in the first direction and the second direction, and can prevent the cover plate 3 from deviating relative to the insulating seat 1, thereby improving the reliability of the cover plate 3 in fixing the conductive terminal 2. Of course, the number of the positioning holes 105 may also be three, four, or the like, which is not limited in the present disclosure.

Furthermore, as shown in FIG. 8, a plurality of first recesses 321 are provided on a circumference of the positioning column 32, and the plurality of first recesses 321 are distributed in a ring around an axis of the positioning column 32. In this embodiment, four first recesses 321 are provided that are distributed in a ring around the axis of the positioning column 32, allowing the positioning column 32 to have a certain amount of elastic deformation, and facilitating the locking connection between the positioning column 32 and the positioning hole 105, which plays a positioning role.

In some embodiments, as shown in FIG. 1, the second end 102 of the insulating seat 1 has a first sidewall 12, and the side of the boss 11 facing away from the insulating seat 1 protrudes relative to the first sidewall 12. When the cover plate 3 is connected to the second end 102 of the insulating seat 1, the side of the cover plate 3 facing away from the accommodating cavity 103 is flush with the first sidewall 12. Since the side of the boss 11 facing away from the insulating seat 1 protrudes relative to the first sidewall 12, the cover plate 3 can be completely embedded in the first opening 111, and the side of the cover plate 3 facing away from the accommodating cavity 103 is flush with the first sidewall 12, so that the boss 11 can protect the cover plate 3 and prevent the cover plate 3 from moving up and down or left and right due to an external force. Therefore, reliability of the rear cover in fixing the conductive terminal 2 can be improved, thereby ensuring the overall conductive performance and normal operation of the connector 100.

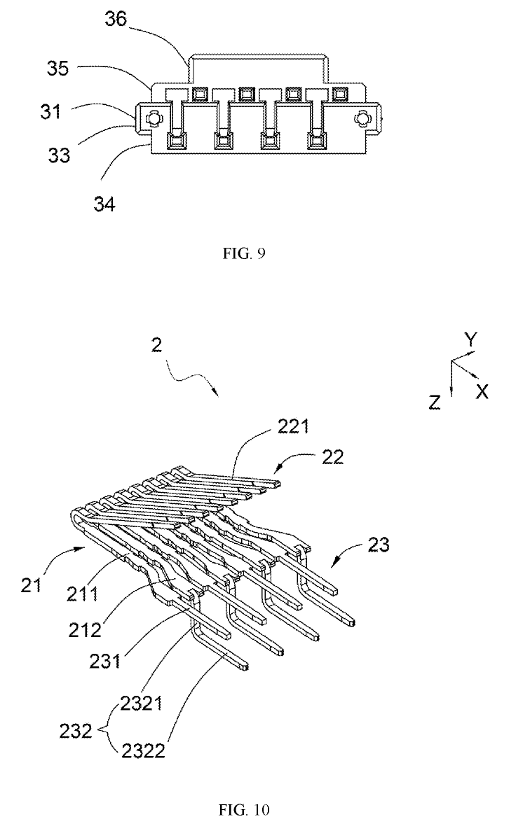

In some embodiments, as shown in FIGS. 5 and 9, the cover plate 3 includes a first step 33 and a second step 34 connected with each other, and the first opening 111 includes a second recess 1111 and a third recess 1112 connected with each other. The first step 33 is interlocked with the second recess 1111, and the second step 34 is interlocked with the third recess 1112. The limiting structure 31 is provided on the first step 33. Since the first opening 111 includes the second recess 1111 and the third recess 1112 connected with each other, a stepped recess is formed in the first opening 111. The first step 33 is interlocked with the second recess 1111, and the second step 34 is interlocked with the third recess 1112. During the process of mounting the cover plate 3 to the insulating seat 1, the first step 33 and the second step 34 play a positioning role, and meanwhile can increase contact area between the cover plate 3 and the boss 11, thereby increasing friction therebetween, preventing the cover plate 3 from falling off the insulating seat 1 due to external pressure, and further improving the reliability of the rear cover in fixing the conductive terminal 2.

It should be noted that two first steps 33 and two second steps 34 are provided. The two first steps 33 are provided opposite to each other in the second direction and are provided on two sides of the cover plate 3, respectively. The two second steps 34 are provided opposite to each other in the second direction and are provided on two sides of the cover plate 3, respectively.

Of course, in another example, the limiting structure 31 may be provided on the second step 34; or, the limiting structure 31 is provided on both the first step 33 and the second step 34.

In another example, as shown in FIGS. 6 and 9, the cover plate 3 may further include a third step 35 and a fourth step 36 connected with each other. An end of the third step 35 away from the fourth step 36 is connected to an end of the first step 33 away from the second step 34. A fifth recess 106 is provided at the second end 102 of the insulating seat 1 corresponding to the third step 35, and a sixth recess 107 is provided at the second end 102 of the insulating seat 1 corresponding to the fourth step 36.

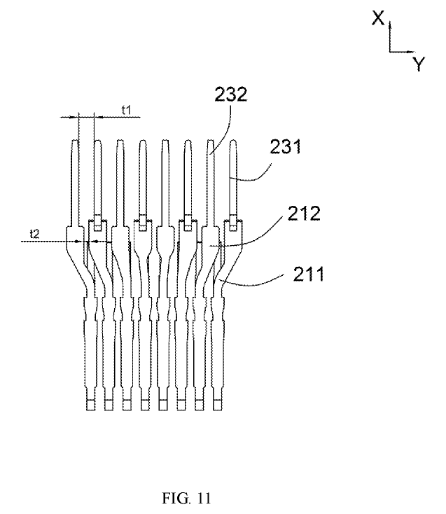

In some embodiments, as shown in FIGS. 10 and 11, the conductive terminal 2 includes a fixing portion 21, a contact portion 22 bent from one end of the fixing portion 21, and a connecting portion 23 extending from the other end of the fixing portion 21. The connecting portion 23 includes a plurality of first pins 231 and a plurality of second pins 232 arranged alternately in the second direction. The fixing portion 21 includes a plurality of first fixing legs 211 and a plurality of second fixing legs 212 arranged alternately in the second direction. The plurality of first fixing legs 211 are connected to the plurality of first pins 231 respectively, and the plurality of second fixing legs 212 are connected to the plurality of second pins 232 respectively. A first spacing t1 is provided between the first pin 231 and the second pin 232 adjacent to each other, and a second spacing t2 is provided between the first fixing leg 211 and the second fixing leg 212 adjacent to each other, with t1 > t2. When the conductive terminal 2 is assembled, crosstalk between the first pin 231 and the second pin 232 adjacent to each other can be prevented, making it easier for the conductive terminal 2 to be connected to the insulating seat 1, thereby improving the convenience of assembly.

Further, as shown in FIG. 10, the first pin 231 extends along the first direction, and the second pin 232 includes a first bent portion 2321 and a second bent portion 2322. One end of the first bent portion 2321 is connected to the second fixing leg 212, and the other end of the first bent portion 2321 is connected to the second bent portion 2322. The first bent portion 2321 extends along a third direction, and the second bent portion 2322 extends along the first direction, with the third direction intersecting the first direction. Optionally, the third direction may be a Z direction shown in the drawings, and two sides of the third direction are referred to as up and down, respectively. It can be understood that, through the above arrangement, an end of the second pin 232 away from the fixing portion 21 and an end of the first pin 231 away from the fixing portion 21 are offset vertically, thereby preventing crosstalk between the first pin 231 and the second pin 232 adjacent to each other, making it easier for the conductive terminal 2 to be connected to the insulating seat 1, and further improving the convenience of assembly.

In some embodiments, as shown in FIG. 8, the cover plate 3 is provided with a plurality of first through holes 37 and a plurality of second through holes 38. The first through holes 37 and the second through holes 38 are misaligned vertically. The first through holes 37 are configured for the first pins 231 to pass through, and the second through holes 38 are configured for the second pins 232 to pass through. During the process of mounting the cover plate 3, the first through holes 37 and the second through holes 38 limit the connecting portion 23 of the conductive terminal 2, limiting displacement of the conductive terminal 2 in the first direction and the second direction, that is, preventing the conductive terminal 2 from moving up and down or left and right. Also, it is possible to prevent the conductive terminal 2 from retreating under a force while being connected to an external electrical appliance, at which time the cover plate 3 plays a limiting and retreat preventing role.

In some embodiments, as shown in FIGS. 8 and 10, a plurality of fourth recesses 39 are provided on the side of the cover plate 3 facing the insulating seat 1, connected to the first bent portions 2321 respectively, and in communication with the second through holes 38. The cover plate 3 is mounted on the insulating seat 1, the second bent portion 2322 passes through the second through hole 38, and the first bent portion 2321 is embedded in the fourth recess 39, thereby playing a role of positioning the conductive terminal 2 to avoid interference and crosstalk between the first pin 231 and second pin 232 adjacent to each other.

In some embodiments, as shown in FIGS. 6 and 10, the contact portion 22 includes a plurality of contact legs 221 provided at intervals and connected to the first fixing legs 211 or the second fixing legs 212. A plurality of partition plates 13 are provided in the insulating seat 1. A limiting space 131 is formed between two adjacent partition plates 13. The limiting space 131 is in communication with the accommodating cavity 103 and is configured to accommodate the contact legs 221. Specifically, a spacing between the two adjacent partition plates 13 is equal to a spacing between two adjacent contact legs 221, so that the plurality of contact legs 221 are connected to the limiting spaces 131 in one-to-one correspondence, which limits displacement of the contact legs 221 in the second direction. Since the conductive terminal 2 is integrally formed, the conductive terminal 2 is also limited.

At the same time, one end of the partition plate 13 extends along the third direction and abuts the fixing portion 21 to limit the displacement of the fixing portion 21 in the third direction. Since the conductive terminal 2 is integrally formed, the conductive terminal 2 is also limited.

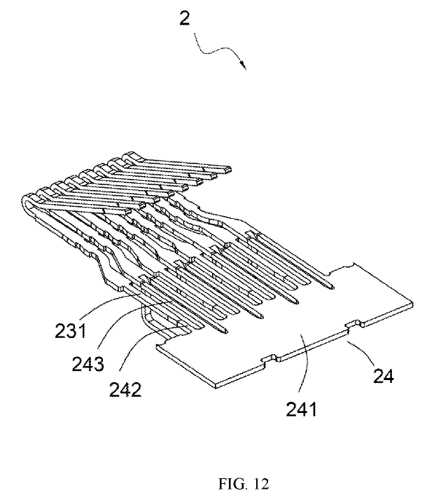

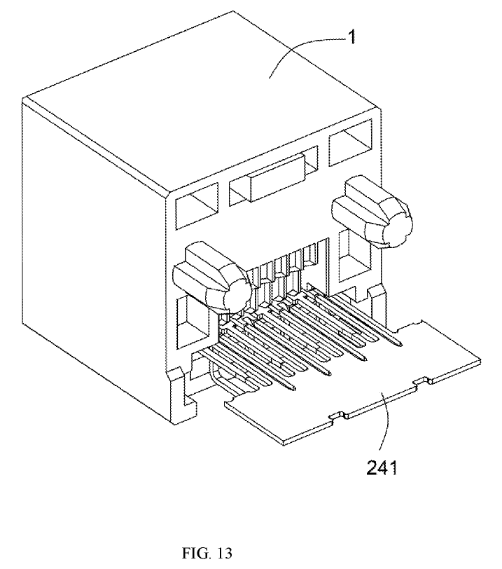

In some embodiments, as shown in FIG. 12, the conductive terminal 2 includes a material tape 24 that includes a connecting plate 241. A plurality of first material bridges 242 and a plurality of second material bridges 243 are provided at an end of the connecting plate 241 facing the insulating seat 1. The first material bridges 242 and the second material bridges 243 are provided at intervals. An end of the first material bridge 242 away from the connecting plate 241 is detachably connected to an end of the first pin 231 away from the first fixing leg 211, and an end of the second material bridge 243 away from the connecting plate 241 is detachably connected to an end of the second pin 232 close to the second fixing leg 212. During the manufacturing process of the conductive terminal 2, the material tape 24 may be subjected to blanking using a stamping process so as to form the first pin 231 and the second pin 232 of the connecting portion 23 by one-time blanking. During the assembly process of the connector 100, an external clamp can be used to clamp the connecting plate 241 of the material tape 24 to push the conductive terminal 2 into the accommodating cavity 103 of the insulating seat 1, facilitating automated production. As shown in FIG. 13, after the conductive terminal 2 is mounted in place, a connection point between the first material bridge 242 and the first pin 231 and a connection point between the second material bridge 243 and the second pin 232 can be cut off to facilitate the subsequent mounting of the cover plate 3.

It should be understood that the terms used herein are only for the purpose of describing specific exemplary embodiments and are not intended to be limiting. Unless the context clearly indicates otherwise, the singular forms “a”, “an” and “the” as used herein can also mean including plural forms. The terms “include”, “contain”, “comprise” and “have” are inclusive and thus indicate the presence of features, steps, operations, elements and/or components described, but do not exclude the presence or addition of one or more other features, steps, operations, elements, components, and/or combinations thereof. The method steps, procedures, and operations described herein are not interpreted as necessarily requiring them to be executed in the specific order described, unless the execution order is explicitly indicated. It should also be understood that additional or alternative steps may be used.

Although a plurality of elements, components, regions, layers and/or sections can be described herein with the terms first, second, third, and the like, they should not be limited by these terms. These terms may be only used to distinguish one element, component, region, layer or section from another ones. Terms such as “first” and “second” and other numerical terms do not imply sequence or order when used herein unless clearly indicated in the context. Accordingly, the first element, component, region, layer or section discussed below may be referred to as a second element, component, region, layer or section without departing from teachings of the exemplary embodiments.

The foregoing description is only the description of embodiments of the disclosure to enable a person skilled in the art to understand or implement the disclosure. Various modifications to these embodiments will be apparent to a person skilled in the art, and general principles defined herein may be implemented in other embodiments without departing from the spirit or scope of the disclosure. Thus, the disclosure is not limited to the embodiments shown herein, but conforms to the widest scope consistent with the principles and novel characteristics applied herein.

What is claimed is:

1. A connector, comprising:
an insulating seat provided with an accommodating cavity and comprising a first end and a second end that are disposed opposite in a first direction, wherein the first end of the insulating seat is provided with a socket, the second end of the insulating seat is provided with a boss, and the boss is provided with a first opening in communication with the accommodating cavity;
a conductive terminal disposed in the accommodating cavity; and
a cover plate embedded in the first opening, configured to fix the conductive terminal, and provided with at least two limiting structures that abut a side of the boss facing the first opening and are disposed opposite in a second direction, the first direction intersecting the second direction.

2. The connector of claim 1, wherein the limiting structure comprises limiting ribs, two of the limiting ribs are provided on two sides of the cover plate, respectively, and an end of the limiting rib extends toward the accommodating cavity.

3. The connector of claim 2, wherein the end of the limiting rib toward the accommodating cavity is provided with a wedge-shaped surface.

4. The connector of claim 1, wherein the second end of the insulating seat is provided with a positioning hole, and a side of the cover plate facing the insulating seat is provided with a positioning column to be connected with the positioning hole.

5. The connector of claim 4, wherein the second end of the insulating seat is provided with a plurality of positioning holes, and the side of the cover plate facing the insulating seat is provided with a plurality of positioning columns to be connected with the plurality of positioning holes, and an end of the positioning column away from the cover plate extends along the first direction.

6. The connector of claim 4, wherein a plurality of first recesses are provided on a circumference of the positioning column, and the plurality of first recesses are distributed in a ring around an axis of the positioning column.

7. The connector of claim 1, wherein the second end of the insulating seat has a first sidewall, and a side of the boss facing away from the insulating seat protrudes relative to the first sidewall, and when the cover plate is connected to the second end of the insulating seat, the side of the cover plate facing away from the accommodating cavity is flush with the first sidewall.

8. The connector of claim 1, wherein the cover plate comprises a first step and a second step connected with each other, the first opening comprises a second recess and a third recess connected with each other, the first step is interlocked with the second recess, and the second step is interlocked with the third recess, and the limiting structure is provided on at least one of the first step and the second step.

9. The connector of claim 1, wherein the conductive terminal comprises a fixing portion, a contact portion bent from one end of the fixing portion, and a connecting portion extending from the other end of the fixing portion;
the connecting portion comprises a plurality of first pins and a plurality of second pins arranged alternately in the second direction; and
the fixing portion comprises a plurality of first fixing legs and a plurality of second fixing legs arranged alternately in the second direction, the plurality of first fixing legs are connected to the plurality of first pins respectively, and the plurality of second fixing legs are connected to the plurality of second pins respectively, a first spacing is provided between the first pin and the second pin adjacent to each other, and a second spacing is provided between the first fixing leg and the second fixing leg adjacent to each other, with the first spacing greater than the second spacing.

10. The connector of claim 9, wherein the first pin extends along the first direction, and the second pin comprises a first bent portion and a second bent portion, one end of the first bent portion is connected to the second fixing leg, and the other end of the first bent portion is connected to the second bent portion, the first bent portion extends along a third direction, and the second bent portion extends along the first direction, with the third direction intersecting the first direction.

11. The connector of claim 10, wherein the cover plate is provided with a plurality of first through holes and a plurality of second through holes, the first through holes and the second through holes are misaligned in the third direction, the first through holes are configured for the first pins to pass through, and the second through holes are configured for the second pins to pass through.

12. The connector of claim 11, wherein a plurality of fourth recesses are provided on a side of the cover plate facing the insulating seat, connected to the first bent portions respectively, and in communication with the second through holes.

13. The connector of claim 9, wherein the contact portion comprises a plurality of contact legs provided at intervals and connected to the first fixing legs or the second fixing legs; and
a plurality of partition plates are provided in the insulating seat, a limiting space is formed between two adjacent partition plates, the limiting space is in communication with the accommodating cavity and is configured to accommodate the contact legs.

14. The connector of claim 9, wherein the conductive terminal comprises a material tape that comprises a connecting plate, a plurality of first material bridges and a plurality of second material bridges are provided at an end of the connecting plate facing the insulating seat, the first material bridges and the second material bridges are provided at intervals, an end of the first material bridge away from the connecting plate is detachably connected to an end of the first pin away from the first fixing leg, and an end of the second material bridge away from the connecting plate is detachably connected to an end of the second pin close to the second fixing leg.

15. The connector of claim 2, wherein the conductive terminal comprises a fixing portion, a contact portion bent from one end of the fixing portion, and a connecting portion extending from the other end of the fixing portion;
the connecting portion comprises a plurality of first pins and a plurality of second pins arranged alternately in the second direction; and
the fixing portion comprises a plurality of first fixing legs and a plurality of second fixing legs arranged alternately in the second direction, the plurality of first fixing legs are connected to the plurality of first pins respectively, and the plurality of second fixing legs are connected to the plurality of second pins respectively, a first spacing is provided between the first pin and the second pin adjacent to each other, and a second spacing is provided between the first fixing leg and the second fixing leg adjacent to each other, with the first spacing greater than the second spacing.

16. The connector of claim 4, wherein the conductive terminal comprises a fixing portion, a contact portion bent from one end of the fixing portion, and a connecting portion extending from the other end of the fixing portion;
the connecting portion comprises a plurality of first pins and a plurality of second pins arranged alternately in the second direction; and
the fixing portion comprises a plurality of first fixing legs and a plurality of second fixing legs arranged alternately in the second direction, the plurality of first fixing legs are connected to the plurality of first pins respectively, and the plurality of second fixing legs are connected to the plurality of second pins respectively, a first spacing is provided between the first pin and the second pin adjacent to each other, and a second spacing is provided between the first fixing leg and the second fixing leg adjacent to each other, with the first spacing greater than the second spacing.

17. The connector of claim 6, wherein the conductive terminal comprises a fixing portion, a contact portion bent from one end of the fixing portion, and a connecting portion extending from the other end of the fixing portion;
the connecting portion comprises a plurality of first pins and a plurality of second pins arranged alternately in the second direction; and
the fixing portion comprises a plurality of first fixing legs and a plurality of second fixing legs arranged alternately in the second direction, the plurality of first fixing legs are connected to the plurality of first pins respectively, and the plurality of second fixing legs are connected to the plurality of second pins respectively, a first spacing is provided between the first pin and the second pin adjacent to each other, and a second spacing is provided between the first fixing leg and the second fixing leg adjacent to each other, with the first spacing greater than the second spacing.

18. The connector of claim 7, wherein the conductive terminal comprises a fixing portion, a contact portion bent from one end of the fixing portion, and a connecting portion extending from the other end of the fixing portion;
the connecting portion comprises a plurality of first pins and a plurality of second pins arranged alternately in the second direction; and
the fixing portion comprises a plurality of first fixing legs and a plurality of second fixing legs arranged alternately in the second direction, the plurality of first fixing legs are connected to the plurality of first pins respectively, and the plurality of second fixing legs are connected to the plurality of second pins respectively, a first spacing is provided between the first pin and the second pin adjacent to each other, and a second spacing is provided between the first fixing leg and the second fixing leg adjacent to each other, with the first spacing greater than the second spacing.

19. The connector of claim 8, wherein the conductive terminal comprises a fixing portion, a contact portion bent from one end of the fixing portion, and a connecting portion extending from the other end of the fixing portion;
the connecting portion comprises a plurality of first pins and a plurality of second pins arranged alternately in the second direction; and
the fixing portion comprises a plurality of first fixing legs and a plurality of second fixing legs arranged alternately in the second direction, the plurality of first fixing legs are connected to the plurality of first pins respectively, and the plurality of second fixing legs are connected to the plurality of second pins respectively, a first spacing is provided between the first pin and the second pin adjacent to each other, and a second spacing is provided between the first fixing leg and the second fixing leg adjacent to each other, with the first spacing greater than the second spacing.

20. The connector of claim 3, wherein the conductive terminal comprises a fixing portion, a contact portion bent from one end of the fixing portion, and a connecting portion extending from the other end of the fixing portion;
the connecting portion comprises a plurality of first pins and a plurality of second pins arranged alternately in the second direction; and
the fixing portion comprises a plurality of first fixing legs and a plurality of second fixing legs arranged alternately in the second direction, the plurality of first fixing legs are connected to the plurality of first pins respectively, and the plurality of second fixing legs are connected to the plurality of second pins respectively, a first spacing is provided between the first pin and the second pin adjacent to each other, and a second spacing is provided between the first fixing leg and the second fixing leg adjacent to each other, with the first spacing greater than the second spacing.
